(19) United States
(12) Patent Application Publication
(10) Pub. No.: US 2013/0126442 A1
(43) Pub. Date: May 23, 2013

(54) METHODS FOR REMOVING CONTAMINANTS FROM WATER

(71) Applicants: Steve T. Bakas, Trevose, PA (US); David M. Polizzotti, Trevose, PA (US); Stephen Robert Vasconcellos, Doylestown, PA (US)

(72) Inventors: Steve T. Bakas, Trevose, PA (US); David M. Polizzotti, Trevose, PA (US); Stephen Robert Vasconcellos, Doylestown, PA (US)

(73) Assignee: GENERAL ELECTRIC COMPANY, Schenectady, NY (US)

(21) Appl. No.: 13/298,612

(22) Filed: Nov. 17, 2011

(51) Int. Cl. C02F 1/72

(52) U.S. Cl. 210/758

(57) ABSTRACT

A method for reducing inorganic contaminant levels during supercritical water oxidation (SCWO) is provided. The method utilizes a fluidized bed reactor wherein inorganic contaminants in the water precipitate out onto the catalyst. The clean water is reclaimed after oxidation of organic contaminants and reduction of inorganic contaminant levels.

### FIELD OF INVENTION

The invention pertains to methods for removing minerals, salts, metals and similar inorganic contaminants from industrial wastewater, such as wastewater from refineries. More particularly, the inorganic contaminants are removed during a supercritical water oxidation process.

### BACKGROUND OF THE INVENTION

Wastewater from refineries and other industrial applications, such as sewage treatment and paper mills, may be contaminated with toxic organic and inorganic compounds. Inorganic contaminants include minerals, salts and metals. Stringent wastewater treatment regulations and a desire to decrease water usage motivates many industrial operators to implement zero liquid discharge (ZLD) systems. ZLD systems eliminate liquid waste streams and produce high purity water for reuse.

Desalination technologies have been developed to reduce salt contaminants. These technologies typically operate by dividing a single aqueous feed stream into two output streams: a product whose properties are tailored to end-use (such as potable water), and a waste stream that contains most of the original salts (and other contaminants) at elevated concentration. Currently, disposal of high salinity desalination streams poses significant problems, especially for inland brackish water desalination units, and is deemed to be a major impediment to implementation of desalination technologies. Discharge of the high salinity waste stream back into the environment inevitably results in an increase in the salinity of either local water sources or those downstream, so it is clearly not sustainable. Sequestration of the high salinity byproduct by injection into deep wells is limited to specific geographic regions and is characterized by high cost and uncertainty about the eventual fate of the high salinity liquid (e.g., will it eventually leach into the groundwater supply?).

There has been much recent activity around “zero liquid discharge” (ZLD) technologies that operate on high salinity waste streams from desalination. These technologies enable enhanced recovery of water and reduce the desalination byproducts to solid salts or slurries. Currently, ZLD technologies rely heavily on expensive and energy-intensive thermal units, such as reverse osmosis (RO) membranes, brine concentrators, evaporators, and crystallizers, or land-intensive evaporation ponds. Recent and near-future technological developments are reducing the cost of ZLD by reducing the size of thermal units, as shown in the ZLD scenario tables below. In the United States today, ZLD is practiced by about 120 industrial facilities, mostly power plants. Municipalities have yet to adopt ZLD, but this picture is on the verge of changing as increasing water scarcity and decreasing cost of ZLD converge.

ZLD scenarios

| % recovery | 95% | 99% | 100% |
|---|---|---|---|
| Unit | RO | evaporator | crystallizer |
| High salinity stream concentration | 40,000 | 200,000 | solid |
| (ppm) | | | |
| Incremental power requirement | 1.0 | 22 | 66 |
| (kWh/m³) | | | |
| Cumulative power requirement | 1.0 | 1.8 | 2.5 |
| (kWh/m³) | | | |

Oxidizing wastewater is one method of eliminating organic contaminants. Oxidation is a reactive process that produces water, CO₂, and nitrogen. One method of removing these organic compounds is Supercritical Water Oxidation (SCWO). In this method, the wastewater is oxidized under supercritical conditions, typically at temperatures between 375 and 650° C. and pressures between 3200 and 5000 psia. SCWO can achieve greater than 99% oxidation with a residence time of a few seconds to a few minutes.

However, the same wastewater is frequently also contaminated with minerals, salts, metals and other inorganic contaminants. Supercritical water is a poor solvent of many inorganic materials. Thus inorganic contaminants form precipitates, resulting in fouling and corrosion of processing lines and equipment, particularly heat exchangers. The fouling and corrosion decreases reactor efficiency and can even damage processing equipment.

Several methods have been utilized to minimize the fouling and corrosion problem. One method is to shut down the reactor and remove fouling through mechanical scrubbing. Another method is to treat the water effluent from the oxidization reactor to remove inorganic precipitates such as minerals, salts, and metals before it is recycled back to the oxidation reactor. In yet another method, the reactor feed stream is alternately supplied with wastewater and a “flushing” stream in which the precipitated inorganic compounds are soluble. All the above methods require the use of extraneous equipment or reactor down-time. Thus there is a strong need for methods that efficiently remove both organic and inorganic contaminants from process wastewater.

### SUMMARY OF THE INVENTION

The embodiments disclosed may be used as part of a zero liquid discharge (ZLD) system for treating industrial wastewater. The methods disclosed herein may replace reverse osmosis membranes, evaporators, and crystallizers units utilized in the traditional ZLD system. In one embodiment, a method for reducing contaminant levels from water during super critical water oxidation (SCWO) is provided. The contaminants reduced comprise both organic and inorganic contaminants. Inorganic contaminants include minerals, salts, and metals. Organic materials include, but are not limited to, recalcitrant organic compounds, aromatic compounds, and petroleum compounds. Specific examples include benzene and toluene.

In another embodiment, SCWO occurs in a fluidized bed reactor with a catalyst. Contaminated water and an oxidant are fed into the fluidized bed reactor. Fresh catalyst is also fed into the fluidized bed reactor. During super critical water oxidation of the organic contaminants, inorganic contaminants precipitate onto the catalyst and the catalyst becomes spent. Optionally, the spent catalyst is then removed from the fluidized bed reactor and replaced with fresh catalyst. After the oxidation and precipitation steps, clean water suitable for reuse is retained.

In another aspect, the catalyst is sand, silica, ceramic, metallic or equivalent particles.

In yet another aspect, the fluidized reactor is an ebullated bed reactor or a riser reactor.

The present invention and its advantages over the prior art will become apparent upon reading the following detailed description and the appended claims with reference to the accompanying drawings. As will be realized the invention is capable of other and different embodiments, and its details are capable of modification in various respects.

### BRIEF DESCRIPTION OF THE DRAWINGS

FIG. 1 is a schematic diagram depicting an exemplary embodiment of a water purification process utilizing an ebullated bed reactor.

FIG. 2 is schematic diagram depicting an exemplary embodiment of a water purification process utilizing a riser reactor.

### DETAILED DESCRIPTION OF EXEMPLARY EMBODIMENTS

The embodiments disclosed may be used as part of a zero liquid discharge (ZLD) system for treating industrial wastewater. The methods disclosed herein may replace reverse osmosis membranes, evaporators, and crystallizers units utilized in the traditional ZLD system. The embodiments combine the principles of SCWO processes and fluidized bed processes to reduce both organic contaminants and inorganic contaminants, including minerals and salts, from water in the same processing step or vessel. Inorganic contaminants include minerals, salts, and metals. Organic materials include, but are not limited to, recalcitrant organic compounds, aromatic compounds, and petroleum compounds. Specific examples include benzene and toluene.

In fluidized bed reactors, the catalyst bed is comprised of solid particles, preferably with a particle size distribution between 10 and 150 μm. The feed stream, typically a gas, is fed upwards through the catalyst bed. The velocity of the feed stream is such that it overcomes the gravitational force on the particles, moving them upwards. Thus, the bed resembles a boiling liquid. The gas passes through the catalyst bed though a disengaging space that is substantially catalyst-free. The gas is then removed from the top of the reactor.

Ebullated bed reactors are similar to fluidized bed reactors and are used in catalytic cracking. In addition to feeding a liquid stream into the bottom of the reactor a gas, typically hydrogen gas, is fed into the bottom of the reactor. Hydrogenated liquid and vapors pass through the catalyst particles into a substantially catalyst-free zone, or disengaging space, and removed at the top of the reactor.

Another type of fluidized bed is a riser reactor. Riser reactors have fast fluidized beds with high velocities. High velocities mean high throughput and lower reactor operational costs. For example, typical residence times are only 1 to 4 seconds. In addition, there are no bubbles, thus the available surface area of the solid catalyst remains high, maximizing mass transfer from the feed stream to the solid catalyst. In a riser reactor operation, the feed stream is injected into the riser base where it contacts the hot catalyst. The feed, hot catalyst, gases and vapors travel up the riser. In cracking operations, the cracking reactions occur as oil vapor travels up the riser. At the end of the riser is a riser termination device, or disengaging device. This device separates the catalyst from vapors. The separated catalyst often goes to a stripper or regenerator before it is recycled back into the riser.

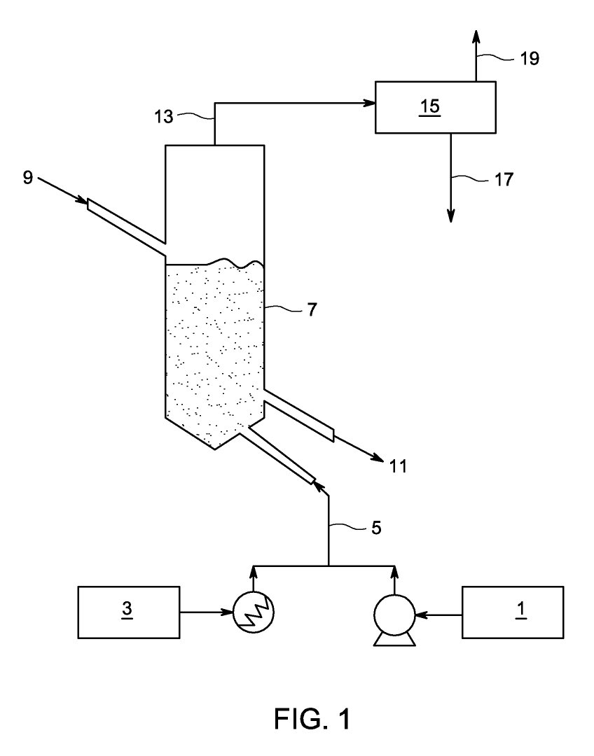

FIG. 1 represents one embodiment utilizing an ebullating reactor process where contaminated water (1) and vaporized oxidant (3) are combined into one feed stream (5) then fed into the bottom of the reactor. Suitable oxidants include, oxygen, hydrogen peroxide, or any other oxidant known in the oxidation art. The feed stream passes through the catalyst bed (7). The aqueous feed stream achieves supercritical state inside the reactor oxidizing the organic portion and causing inorganic minerals and salts to precipitate out.

The catalyst bed is comprised of solid particles that provide a surface for inorganic salts and minerals to attach to as they precipitate out of the supercritical water. In addition to providing a precipitation surface, the particles will prevent precipitation within the reactor by abrading the reactor walls. The catalyst may be catalytic, reactive, or inert, but preferably an inert material and inexpensive material such as fancy sand or silica, ceramic, or metallic particles. Optionally, fresh catalyst is fed near the top of the reactor (9) and spent catalyst exits near the bottom of the reactor (11).

Reactor effluent (13) exits the top of the ebullating reactor. This effluent is composed of clean water vapor and gaseous byproducts such as CO₂ and nitrogen. The effluent stream enters a liquid/gas separator (15). Exiting the separator is a clean liquid water stream (17) and gaseous stream (19), comprising CO₂ and nitrogen. The clean water can be reused elsewhere in the plant or discharged directly to a receiving body like a river, lake, or ocean.

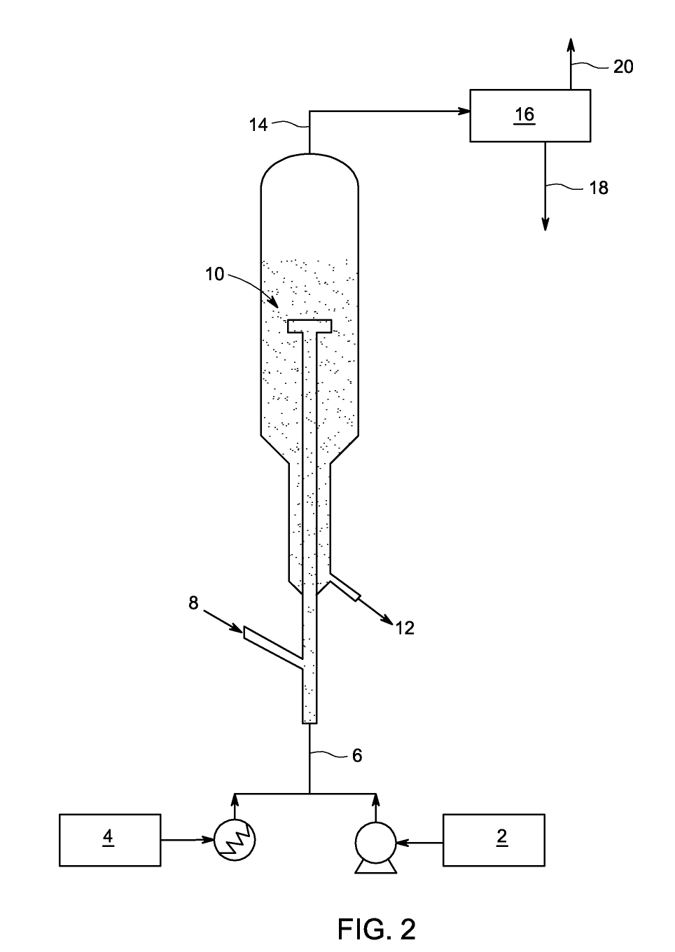

FIG. 2 represents another embodiment utilizing a riser reactor process where contaminated water (2) and vaporized oxidant (4) are combined into one feed stream (6) then fed into the bottom of the riser. Suitable oxidants include oxygen, hydrogen peroxide, or any other oxidant known in the oxidation art. Catalyst is also fed into the bottom of the riser (8). Optionally, fresh catalyst may be fed into the bottom of the riser (8). As the feed stream travels up the riser, the aqueous portion achieves supercritical state, oxidizing the organic portion and causing inorganic minerals and salts to precipitate out (10).

The catalyst material is comprised of solid particles that provide a surface for inorganic salts and minerals to attach to as they precipitate out of the supercritical water. In addition to providing a precipitation surface, the particles will prevent precipitation within the reactor by abrading the reactor walls. The catalyst may be catalytic, reactive, or inert, but preferably an inert material and inexpensive material such as fancy sand or silica, ceramic, or metallic particles. Catalyst with precipitates exits out of the bottom of the reactor (12).

Reactor effluent (14) exits the top of the riser reactor. This effluent is composed of clean water vapor and gaseous byproducts such as CO₂ and nitrogen. The effluent stream enters a liquid/gas separator (16). Exiting the separator is a clean liquid water stream (18) and gaseous stream (20), comprising CO₂ and nitrogen. The clean water can be reused elsewhere in the plant or discharged directly to a receiving body like a river, lake, or ocean.

SCWO also produces useful energy, making wastewater potentially valuable to operators of refineries and other industrial applications. Accordingly, in another embodiment, the BTU value, or thermal energy, of industrial waste stream is recovered.

While this invention has been described in conjunction with the specific embodiments described above, it is evident that many alternatives, combinations, modifications and variations are apparent to those skilled in the art. Accordingly, the preferred embodiments of this invention, as set forth above are intended to be illustrative only, and not in a limiting sense. Various changes can be made without departing from the spirit and scope of this invention. Therefore, the technical scope of the present invention encompasses not only those embodiments described above, but also all that fall within the scope of the appended claims.

What is claimed is:

1. A method for reducing contaminant levels from water during supercritical water oxidation, comprising:
(a) supplying a fluidized bed reactor with a catalyst;
(b) feeding a contaminated water stream into said fluidized bed reactor;
(c) feeding an oxidant steam into said fluidized bed reactor with a catalyst;
(d) oxidizing a portion of said contaminants; and
(f) allowing an insoluble portion of said contaminants to precipitate onto said catalyst.

2. The method of claim 1, further comprising after step (f), the step of reclaiming clean water after said oxidation and said precipitation of said contaminants.

3. The method of claim 1, further comprising:
(g) removing catalyst with precipitates as spent catalyst; and
(h) replacing said spent catalyst with fresh catalyst.

4. The method of claim 1, wherein said catalyst is sand, silica, ceramic, metallic, or equivalent particles.

5. The method of claim 1, wherein said fluidized bed reactor is an ebullated bed reactor.

6. The method of claim 1, wherein said fluidized bed reactor is a riser reactor.

7. The method of claim 1, wherein said precipitated portion of contaminants comprise inorganic contaminants.

8. The method of claim 7, wherein said inorganic contaminants comprise minerals, salts, or metals.

9. The method of claim 1, wherein said oxidized portion of contaminants comprise organic contaminants.

10. The method of claim 9, wherein said organic contaminants comprise recalcitrant organic compounds, petroleum compounds, benzene, or toluene.

11. The method of claim 2, wherein thermal energy of said clean water is recovered.

12. The method of claim 1, wherein said fluidized bed reactor is part of a zero liquid discharge system.
